(19) United States
(12) Patent Application Publication
(10) Pub. No.: US 2026/0336148 A1
(43) Pub. Date: Oct. 29, 2026

(54) Blade holder, cutting device comprising said blade holder and method for adjusting an orientation of a cutting blade

(71) Applicant: VMI Holland B.V., EPE (NL)

(72) Inventors: Jaron MOL, EPE (NL); Mark VAN VELZEN, EPE (NL); Mattheus Jacobus KAAGMAN, EPE (NL); Petrus Franciscus Johannes VAN OLPHEN, EPE (NL)

(21) Appl. No.: 19/110,010

(22) PCT Filed: Jul. 20, 2023
(86) PCT No.: PCT/NL2023/050392

§ 371 Date: Mar. 7, 2025

(30) Foreign Application Priority Data
Sep. 8, 2022 (NL) 2032987

(51) Int. Cl. B26D 7/26

(52) U.S. Cl. CPC B26D 7/2614; B26D 7/2628

(57) ABSTRACT

A blade holder for holding a cutting blade relative to a cutting line, the blade holder is configured for holding the cutting blade such that a cutting edge of said cutting blade obliquely intersects with the cutting line at an incision point, wherein the blade holder mechanically defines a first adjustment axis for angular adjustment of an orientation of the cutting blade about said first adjustment axis wherein the first adjustment axis intersects with the incision point. Also disclosed is a cutting device including the aforementioned blade holder and to a method for adjusting an orientation of a cutting blade using the aforementioned blade holder.

### BACKGROUND

The invention relates to a blade holder, a cutting device comprising said blade holder and a method for adjusting an orientation of a cutting blade held.

FIG. 5 shows a known cutting device 200 for cutting an elastomeric profile to form a tire component. The cutting device 200 comprises a cutting blade 9 and a blade holder 201 for moving the cutting blade 9 along a cutting line L in a cutting direction C parallel to a support plane V. The cutting blade 9 is provided with a straight cutting edge 91 for cutting through the elastomeric profile at said support plane V. The known blade holder 201 allows for adjustment of the orientation and the relative position of the cutting blade 9 with respect to the support plane V. In particular, the cutting blade 9 is rotatable about a horizontal axis A201 to adjust a skive angle of the cutting blade 9, about a vertical axis A202 to adjust an angle of attack of the straight cutting edge 91, and about a tilt axis A203 at the center line S of the cutting blade 9 to adjust an inclination angle of the cutting edge 91. Moreover, the cutting blade 9 can be displaced linearly along a combination of two of the axes F, G to adjust the height and depth of the cutting edge 91 with respect to the support plane V.

Prior to cutting, the orientation and the relative position of the cutting blade 9 with respect to the support plane V is carefully adjusted such that the cutting edge 91 of the cutting blade 9, at a leading tip 92 thereof, intersects with the cutting line L at the desired skive angle, angle of attack and inclination angle.

### SUMMARY OF THE INVENTION

A disadvantage of the known blade holder 201 in FIG. 5 is that the aforementioned axes for adjustment of the skive angle, the angle of attack and the cutting edge inclination angle do not have a common point of intersection. Moreover, each of the axes A201, A202, A203 is spaced apart from the leading tip 92 of the cutting edge 91. Assuming that the leading tip 92 of the cutting edge 91 is aligned perfectly with the cutting line L prior to adjustment, each subsequent angular adjustment of the cutting blade 9 about any of the axes A201, A202, A203 causes a displacement of the leading tip 92 away from its initial alignment with the cutting line L. Consequently, once the desired skive angle, angle of attack and inclination angle have been set, further corrective adjustment of both the height position and the horizontal position of the cutting edge 91 is required to correct for the displacements caused by the angular adjustments. The further corrective adjustment may also have an effect on the accuracy of the angles that have already been set, resulting in inaccurate cutting and requiring additional verifications or corrective adjustments.

As a result, the process of adjusting the orientation and relative position of the cutting blade 9 with respect to the support plane V can be very complex and time consuming.

It is an object of the present invention provide a blade holder, a cutting device comprising said blade holder and a method for adjusting an orientation of a cutting blade, wherein the process of adjusting the orientation of the cutting blade can be simplified.

According to a first aspect, the invention provides a blade holder for holding a cutting blade relative to a cutting line, wherein the blade holder is configured for holding the cutting blade such that a cutting edge of said cutting blade obliquely intersects with the cutting line at an incision point, wherein the blade holder mechanically defines a first adjustment axis for angular adjustment of an orientation of the cutting blade about said first adjustment axis, wherein the first adjustment axis intersects with the incision point.

By aligning the first adjustment axis with the incision point, the intersection between the cutting edge and the cutting line at the incision point can be continuously maintained while angularly adjusting the orientation of the cutting blade about said first adjustment axis. Hence, corrective adjustments in any other degrees of freedom of the cutting blade are required after the angular adjustment of the orientation of the cutting blade about said first adjustment axis. The process of adjusting the orientation of the cutting blade can therefore be simplified significantly, is less time consuming and less prone to inaccuracies.

In one embodiment the blade holder mechanically defines a second adjustment axis for angular adjustment of the orientation of the cutting blade about said second adjustment axis, wherein the second adjustment axis intersects with the incision point. By aligning both the first adjustment axis and the second adjustment axis with the incision point, the intersection between the cutting edge and the cutting line at the incision point can be continuously maintained while angularly adjusting the orientation of the cutting blade about both said first adjustment axis and said second adjustment axis. This has all the technical advantages as mentioned before and the additional technical advantage that angular adjustment of the orientation of the cutting blade about one of the first adjustment axis and the second adjustment axis does not influence a previously set orientation of the cutting blade about the other of the first adjustment axis and the second adjustment axis. In other words, the orientation of the cutting blade can be set about each adjustment axis individually, without affecting the accuracy of the orientation of the cutting blade about the other adjustment axis. Hence, once the orientation of the cutting blade about one of the adjustment axes has been set and fixed, it does not need to be checked again for accuracy or corrective actions.

Preferably, the blade holder mechanically defines a third adjustment axis for angular adjustment of the orientation of the cutting blade about said third adjustment axis, wherein the third adjustment axis intersects with the incision point. By aligning all three adjustment axes with the incision point, the intersection between the cutting edge and the cutting line at the incision point can be continuously maintained while angularly adjusting the orientation of the cutting blade about any of the three adjustment axes. This has all the technical advantages as mentioned before and the additional technical advantage that angular adjustment of the orientation of the cutting blade about any of the three adjustment axes does not influence a previously set orientations of the cutting blade about the other two adjustment axes.

In another embodiment the first adjustment axis extends in one of a horizontal direction, a vertical direction or an oblique direction. An angular adjustment about the first adjustment axis extending in a horizontal direction may be used to set a first angle corresponding or related to a skive angle. An angular adjustment about the first adjustment axis extending in a vertical direction may be used to set a second angle corresponding or related to an angle of attack. An angular adjustment about the first adjustment axis extending in an oblique direction may be used to set a third angle corresponding or related to an edge inclination angle.

In another embodiment, dependent on the embodiment that introduced the second adjustment axis, the first adjustment axis and the second adjustment axis extend in respective ones of a horizontal direction, a vertical direction and an oblique direction. It will be understood that any combination of the aforementioned directions for the respective adjustment axes may be used to set any combination of the angles described in the previous embodiment.

In another embodiment, dependent on the embodiment that introduced the third adjustment axis, the first adjustment axis extends in a horizontal direction, the second adjustment axis extends in a vertical direction and the third adjustment axis extends in an oblique direction. It will be understood that any combination of the aforementioned directions for the respective adjustment axes may be used to set any combination of the angles described in the previous two embodiments.

In another embodiment the cutting edge defines a straight edge profile, wherein the cutting blade has a blade body with a center line perpendicular to the edge profile, wherein the first adjustment axis extends in one of:
a horizontal direction in an edge plane coincident with the edge profile and perpendicular to the center line;
a vertical direction; and
a direction parallel to the center line.

In another embodiment, dependent on the embodiment that introduced the second adjustment axis, the cutting edge defines a straight edge profile, wherein the cutting blade has a blade body with a center line perpendicular to the edge profile, wherein the first adjustment axis and the second adjustment axis extend in respective ones of:
a horizontal direction in an edge plane coincident with the edge profile and perpendicular to the center line;
a vertical direction; and
a direction parallel to the center line.

In another embodiment, dependent on the embodiment that introduced the third adjustment axis, the cutting edge defines a straight edge profile, wherein the cutting blade has a blade body with a center line perpendicular to the edge profile, wherein:
the first adjustment axis extends in a horizontal direction in an edge plane coincident with the edge profile and perpendicular to the center line;
the second adjustment axis extends a vertical direction; and
the third adjustment axis extends in a direction parallel to the center line.

The three embodiments above describe, for an increasing number of adjustment axes, more specifically the directions in which the respective adjustment axes extend, corresponding to the angles (the skive angle, the angle of attack and the edge inclination angle) previously mentioned in relation to said directions.

In another embodiment the adjustment of the orientation of cutting blade about the first adjustment axis determines one of a skive angle, an angle of attack and an edge inclination angle.

In another embodiment, dependent on the embodiment that introduced the second adjustment axis, the adjustment of the orientation of cutting blade about the first adjustment axis and the second adjustment axis determine respective ones of a skive angle, an angle of attack and an edge inclination angle.

In another embodiment, dependent on the embodiment that introduced the third adjustment axis, the adjustment of the orientation of cutting blade about the first adjustment axis, the second adjustment axis and the third adjustment axis determine a skive angle, an angle of attack and an edge inclination angle, respectively.

The three embodiments above describe, for an increasing number of adjustment axes, more specifically the angles of the orientation of the cutting blade which can be adjusted using the blade holder according to the present invention.

In another embodiment the blade holder comprises one or more angular adjustment guides for guiding the angular adjustment of the orientation of the cutting blade about at least the first adjustment axis. The one or more adjustment guides can be used to mechanically guide the angular adjustment about the respective adjustment axes. The one or more adjustment guides may for example be formed by slots, pins, rails, shafts, linkages, guide shoes, gears and the like.

In one embodiment thereof the one or more angular adjustment guides extend physically at least at the first adjustment axis. This can be done when presence of the one or more angular adjustment guides at the first adjustment axis does not interfere with the cutting process.

Alternatively, the one or more angular adjustment guides are spaced apart from at least the first adjustment axis. Hence, the rotation about the first adjustment axis can be obtained in a virtual manner. This may be convenient when there is no way of providing the one or more angular adjustment guides at the first adjustment axis because of interference with the cutting process. This is particularly true when the first adjustment axis extends in a support plane that includes the cutting line.

In a further embodiment the blade holder comprises one or more holder members which are interconnected using the one or more angular adjustment guides so as to be movable with respect to each other about at least the first adjustment axis, wherein one holder member of the one or more holder members is configured for carrying the cutting blade. Hence, the holder members can form a chain of articulating segments to provide the cutting blade with a degree of freedom to rotate about at least the first adjustment axis.

In another embodiment the blade holder comprises a height adjustment section for linearly adjusting a height of the cutting blade relative to the cutting line in a height direction. Depending on the configuration and/or dimensions of the cutting blade, the height of the cutting blade can be linearly adjusted to make sure that the incision point is coincident with and/or located in a support plane that includes the cutting line.

In another embodiment the blade holder comprises one or more instruments for reading one or more angles adjusted by the angular adjustment of the orientation of the cutting blade. Preferably, the one or more instruments comprises at least one protractor. Hence, the relevant angles of the orientation of the cutting blade can be checked, adjusted and/or set visually.

According to a second aspect, the invention provides a blade holder for holding a cutting blade relative to a cutting line, wherein the blade holder mechanically defines a first adjustment axis and a second adjustment axis for angular adjustment of an orientation of the cutting blade about said first adjustment axis and said second adjustment axis, respectively, wherein the first adjustment axis and the second adjustment axis intersect with an incision point, common to both the first adjustment axis and the second adjustment axis, at the cutting line.

By aligning both the first adjustment axis and the second adjustment axis with the same incision point, a leading tip of the cutting blade can be continuously maintained at said incision point while angularly adjusting the orientation of the cutting blade about both said first adjustment axis and said second adjustment axis. This has all the technical advantages as mentioned before in relation to the first aspect of the invention and the additional technical advantage that angular adjustment of the orientation of the cutting blade about one of the first adjustment axis and the second adjustment axis does not influence a previously set orientation of the cutting blade about the other of the first adjustment axis and the second adjustment axis. In other words, the orientation of the cutting blade can be set about each adjustment axis individually, without affecting the accuracy of the orientation of the cutting blade about the other adjustment axis. Hence, once the orientation of the cutting blade about one of the adjustment axes has been set and fixed, it does not need to be checked again for accuracy or corrective actions.

In an embodiment thereof, the blade holder mechanically defines a third adjustment axis for angular adjustment of an orientation of the cutting blade about said third adjustment axis, wherein the third adjustment axis intersects with the incision point, common to the first adjustment axis, the second adjustment axis and the third adjustment axis, at the cutting line. By aligning all three adjustment axes with the same incision point at the cutting line, the orientation of the cutting blade about any of the three adjustment axes does not influence a previously set orientations of the cutting blade about the other two adjustment axes.

It will be understood that the blade holder according to the second aspect of the invention may be combined with any of the features described in the embodiments of the blade holder according to the first aspect of the invention, applied individually where possible.

According to a third aspect, the invention provides a cutting device comprising the blade holder according to any one of the embodiments of the first aspect or the second aspect of the invention and a cutting blade held by said blade holder, wherein the cutting blade has a cutting edge that define an edge profile that intersects with the cutting line at the incision point.

The cutting device according to the third aspect of the invention includes the blade holder according to the first aspect or the second aspect of the invention and thus has the same technical advantages, which will not be repeated hereafter.

In one embodiment of the cutting device the cutting edge terminates with a leading tip at the incision point.

In another embodiment of the cutting device the cutting blade is configured for ultrasonic cutting.

According to a fourth aspect, the invention provides a method for adjusting an orientation of a cutting blade using the blade holder according to any one of the embodiments of the first aspect or the second aspect of the invention, wherein the method comprises the step of:
angularly adjusting the orientation of the cutting blade about the first adjustment axis.

The method according to the fourth aspect of the invention relates to the practical implementation of the blade holder according to the first aspect or the second aspect of the invention and thus has the same technical advantages, which will not be repeated hereafter.

In one embodiment the blade holder mechanically defines a second adjustment axis for angular adjustment of the orientation of the cutting blade about said second adjustment axis, wherein the second adjustment axis intersects with the incision point, wherein the method further comprises the step of:
angularly adjusting the orientation of the cutting blade about the second adjustment axis.

In another embodiment the blade holder mechanically defines a third adjustment axis for angular adjustment of the orientation of the cutting blade about said third adjustment axis, wherein the third adjustment axis intersects with the incision point, wherein the method further comprises the step of:
angularly adjusting the orientation of the cutting blade about the third adjustment axis.

In another embodiment the method further comprises the step of:
linearly adjusting a height of the cutting blade relative to the cutting line in a height direction.

In another embodiment the cutting blade is configured for ultrasonic cutting. An ultrasonic cutting blade, also known as a ‘sonotrode’, is configured for slicing through a material, such as a tire component, while moving in a fixed orientation in a linear manner along a cutting line. Hence, the movement of the cutting blade is cross-cutting movement, in contrast to a guillotine movement used in other known, non-ultrasonic cutting processes.

In another embodiment the method comprises the step of:
cutting one or more tire components to length using the cutting blade. When cutting tire components, the orientation of the cutting blade has to be changed regularly, for example, in response to a changeover to a different tire configuration. Hence, applying the blade holder according to the present invention in the field of tire building has the technical advantage that the adjustment of the orientation of the cutting blade is considerably less complex, less time consuming, more accurate and less prone to errors.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIG. 1 shows a side view of a cutting device with a blade holder and a cutting blade for cutting a tire component according to the invention;

FIG. 2 shows a view of the cutting blade according to FIG. 1 perpendicular to a first adjustment axis;

FIG. 3 shows a view of the cutting blade according to FIG. 1 perpendicular to a second adjustment axis;

FIG. 4 shows a view of the cutting blade according to FIG. 1 perpendicular to a third adjustment axis; and

FIG. 5 shows a side view of a known cutting device according to the prior art.

### DETAILED DESCRIPTION OF THE INVENTION

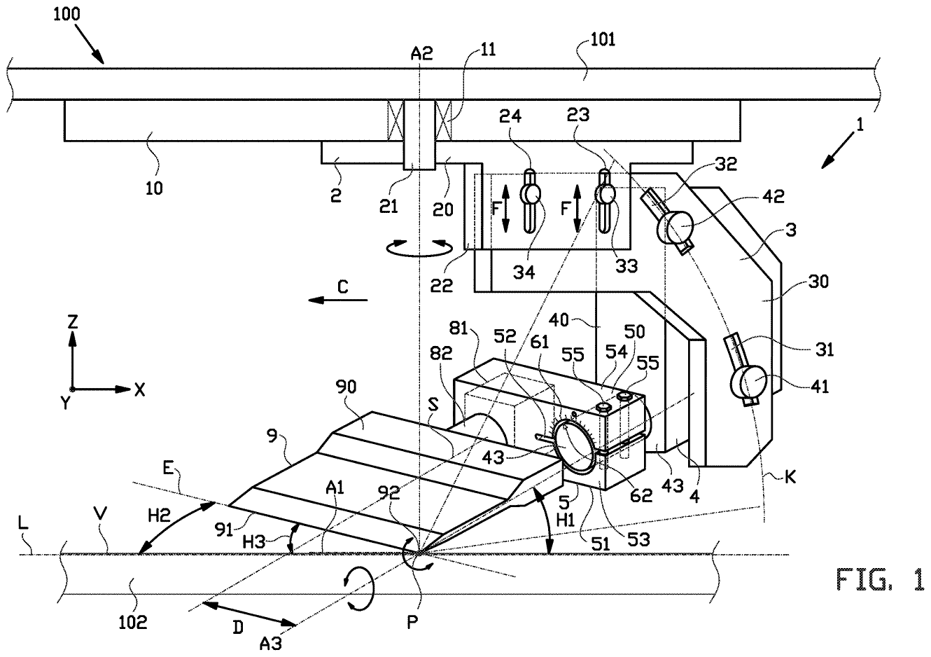

FIG. 1 shows a cutting device 100 for cutting a tire component (not shown). The tire component may for example be a liner, a sidewall, a body ply or a combination thereof, the latter also known as a ‘pre-assembly’. The cutting device 100 is used to cut the tire component to a suitable length for application around a tire building drum downstream of the cutting device 100.

The cutting device 100 comprises a shearing blade or a cutting blade 9. The cutting blade 9 has a blade body 90 with a shearing edge or cutting edge 91. The cutting edge 91 extends along, is coincident with and/or defines an edge line or edge profile E. In this example, the cutting edge 91 and/or the edge profile E is flat or straight. Alternatively, the cutting edge and/or the edge profile may be curved, non-linear or a combination thereof. The cutting blade 9 is configured for slicing through the tire component while moving in a fixed or stationary orientation in a linear manner along a cutting line L. Hence, the movement of the cutting blade 9 is cross-cutting movement, in contrast to a guillotine movement used in other known cutting processes. The cutting blade 9 is arranged to be held with its cutting edge 91 extending in an oblique orientation to the cutting line L. As such, the cutting edge 91, at one of its ends—hereafter referred to as the ‘leading tip’ 92—cuts first into the tire component with the rest of the cutting edge 91 progressively slicing into the tire component as the cutting blade 9 is moved along the cutting line L.

In this example, the cutting blade 9 is arranged for ultrasonic cutting, and may therefore be considered a ‘sonotrode’ or an ‘ultrasonic blade’. The blade body 90 has a center line S extending perpendicular to the cutting edge 91 and/or the edge profile E. In this example, the blade body 90 is symmetrical or substantially symmetrical about the center line S in at least one direction perpendicular to said center line S. More in particular, the blade body 90 has a wedge shaped cross section symmetrical to the center line S.

The cutting device 100 further comprises a transducer or converter 81 for converting alternating current into a vibration that is transmitted onto the cutting blade 9. The cutting device 100 is provided with a mounting member 82, known as a ‘booster’, that connects the blade body 90 to the converter 81 and that increases or ‘boosts’ the amplitude of the vibrations.

The cutting device 100 further comprises a blade holder 1 for holding the cutting blade 9 relative to the cutting line L. In this example, the cutting device 100 also comprises a cutting guide 101, such as a rail or a beam, for supporting the blade holder 1. In particular, the cutting guide 101 extends parallel to the cutting line L and the blade holder 1 is movable in a cutting direction C along the cutting guide 101 parallel to said cutting line L.

The cutting device 100 is further provided with a cutting a cutting bar or an anvil 102 opposite to the cutting blade 9 for supporting the tire component in a support plane V along the cutting line L. The anvil 102 and the cutting blade 9 cooperate to cut the tire component along the cutting line L.

The blade holder 1 is configured such that, when the cutting blade 9 is fitted to and/or held by said blade holder 1, the cutting edge 91 of the cutting blade 9 obliquely intersects with the cutting line L at an incision point P. In particular, the incision point P is located at the intersection between the cutting edge 91 and the cutting line L. More in particular, the incision point P is located at the leading tip 92 of the cutting edge 91, i.e. at the position where the cutting edge 91 first cuts or makes its first incision in the tire component when moving in the cutting direction C along the cutting line L.

As further shown in FIG. 1, the blade holder 1 defines three adjustment axes A1, A2, A3 for angular adjustment of the orientation of the cutting blade relative to the support plane V and/or the cutting line L.

In the description hereafter, the three adjustment axes A1, A2, A3 are specifically defined as the ‘first adjustment axis’ with reference to numeral A1, the ‘second adjustment axis’ with reference to numeral A2 and the ‘third adjustment axis’ with reference to numeral A3. However, it is noted that, in the context of the claims, the ordinal numbers ‘first’, ‘second’ and ‘third’ are used interchangeably for each of the adjustment axes A1, A2, A3. Hence, in the claims, unless specified otherwise, the ‘first’ adjustment axis may relate to each of the adjustment axes A1, A2, A3 and the first′ and ‘second’ adjustment axes may relate to any combination of two of the three adjustment axes A1, A2, A3.

To clearly define the adjustment axes A1, A2, A3, FIG. 1 schematically shows a coordinate system of a first orthogonal axis X, a second orthogonal axis Y and a third orthogonal axis Z that together defining a three dimensional space. The support plane V extends in a plane defined by the first orthogonal axis X and the second orthogonal axis Y. In this example, the first orthogonal axis X and the second orthogonal axis Y are both horizontal or substantially horizontal. Likewise, the support plane V extends horizontally or substantially horizontally. The first orthogonal axis X extends parallel to the cutting direction C and the second orthogonal axis Y extends perpendicular to the cutting direction c. The third orthogonal axis Z extends perpendicular to the first orthogonal axis X and the second orthogonal axis Y, and therefore perpendicular to the support plane V. In this example, the third orthogonal axis Z extends vertically or substantially vertically.

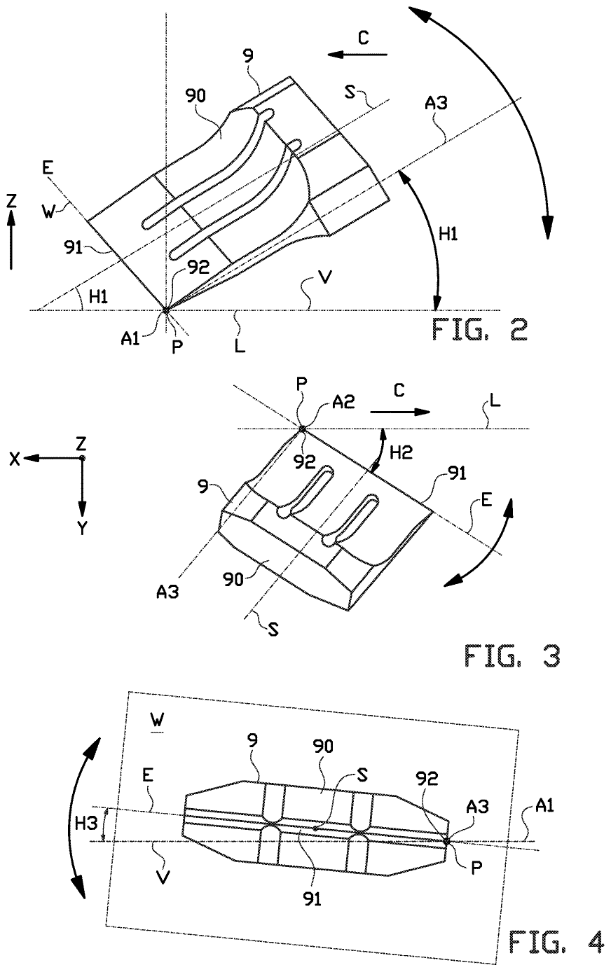

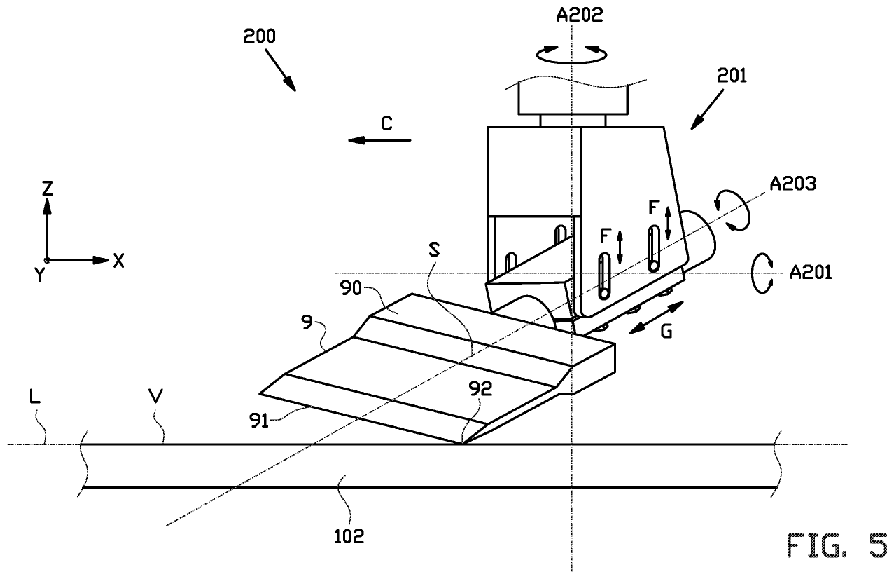

As shown in FIGS. 1 and 2, the first adjustment axis A1 extends in or parallel to the support plane V. In particular, the first adjustment axis A1 extends at an intersection between the support plane V and an edge plane W coincident with the edge profile L and perpendicular to the center line S of the cutting body 90. In this example, the first adjustment axis A1 extends horizontally or substantially horizontally. The cutting blade 9 is held by the blade holder 1 such that the center line S of the blade body 90 extends at a first angle H1 to the support plane V about said first adjustment axis A1. The first angle H1 may also be referred to as or related to a ‘skive angle’. In the example as shown, the first angle H1 is non-right or oblique.

As shown in FIGS. 1 and 3, the second adjustment axis A2 extends perpendicular to the support plane V and/or parallel to the third orthogonal axis Z. In this example, the second adjustment axis A2 extends vertically or substantially vertically. The cutting blade 9 is held by the blade holder 1 such that the cutting edge 91 and/or the edge profile E extends at a second angle H2 to the cutting line L about said second adjustment axis A2. The second angle H2 may also be referred to as or related to an ‘angle of attack’. In the example as shown, the second angle H2 is non-right or oblique.

As shown in FIGS. 1 and 4, the third adjustment axis A3 extends parallel to the center axis S of the blade body 90 and/or perpendicular to the edge plane W. The cutting blade 9 is held by the blade holder 1 such that the cutting edge 91 and/or the edge profile E extends at a third angle H3 to the support plane V about the third adjustment axis A3. The third angle H3 may also be referred to as or related to an ‘edge inclination angle’. In the example as shown, the third angle H1 is non-right or oblique.

The aforementioned adjustment axes A1, A2, A3 are each defined mechanically by the blade holder 1, meaning that the blade holder 1, for each adjustment axis A1, A2, A3, has one or more structural components that mechanically predefine or predetermine the movement of the cutting blade 9 about the respective adjustment axis A1, A2, A3. In other words, the movement the cutting blade 9 about each of the adjustment axes A1, A3, A3 is a mechanically restricted to said movement rather a mechanically unrestricted, numerically controlled and/or complex movement about multiple degrees of freedom.

Moreover, note that, as best seen in FIG. 1, the blade holder 1 is mechanically configured such that at least one of the three adjustment axes A1, A2, A3 intersects with the incision point P. In this example, all three adjustment axes A1, A2, A3, intersect with the incision point P. In other words, all three adjustment axes A1, A2, A3 pass through the same incision point P. As mentioned before, the incision point P corresponds to the location of the leading tip 92 of the cutting edge 91 when the cutting blade 9 is fitted to the blade holder 1.

As such, the orientation of the cutting blade 9 can be adjusted about any one of the three adjustment axes A1, A2, A3 individually without said individual adjustment affecting orientation of the cutting blade 9 about the other of the three adjustment axes A1, A2, A3. In other words, when adjusting one of the aforementioned angles H1, H2, H3, the other angles H1, H2, H3 can remain the same. Hence, each angle H1, H2, H3 can be adjusted individually and in a reliable manner without requiring correction to any of the other angles H1, H2, H3 as a result of said individual adjustment.

The structural components of the blade holder 1 responsible for mechanically defining the aforementioned adjustment axes A1, A2, A3 will be discussed hereafter in more detail with reference to FIG. 1.

As shown in FIG. 1, the blade holder 1 comprises a base 10 that is connected to, carried by and/or movable along the cutting guide 101. The blade holder 1 further comprises a first holder member 2 that is rotatable relative to the base 10 about the second adjustment axis A2. In particular, the first holder member 2 comprises a first holder body 20 and a first angular adjustment guide, in this example in the form of a physical angular adjustment shaft 21, extending at the second adjustment axis A2 for rotatably connecting the first holder body 20 to the base 10 about said second adjustment axis A2. The base 10 is provided with a rotary bearing for receiving the angular adjustment shaft 21 and facilitating said rotation. Alternatively, the angular adjustment shaft 21 may be provided at the base 10 and the rotary bearing may be provided at the first holder member 2. A suitable fastener, clamp or fixation member (not shown) may be provided at or between the first holder member 2 and the base 10 to releasably fixate the angular orientation f the first holder member 2 about the second adjustment axis A2.

In this exemplary embodiment, the first holder body 20 also comprises a height adjustment section 22 with two height adjustment slots 23, 24 extending in a height direction F. In this example, the height direction F is vertical and/or parallel to the third orthogonal axis Z.

The blade holder 1 further comprises a second holder member 3 that is movable relative to the first holder member 2 in the height direction F to adjust the height of the cutting blade 9 relative to the anvil 102, the support plane V and/or the cutting line L. In particular, the second holder member 3 comprises a second holder body 30 and two height adjustment bolts 33, 34 connected to said second holder body 30 and slidably engaged with the respective height adjustment slots 23, 24 at the height adjustment section 22 of the first holder body 20 for facilitating the aforementioned height adjustment in the height direction F. The height adjustment bolts 33, 34 are fastened and/or tightened to releasably fixate the second holder body 30 relative to the first holder body 20 in the height direction F at a desired height position.

As further shown in FIG. 1, the second holder member 3 is provided with a second angular adjustment guide, in this example comprising two angular adjustment slots 31, 32. In this example, the angular adjustment slots 31, 32 extend arcuately, coinciding with an arc G that is concentric to the first adjustment axis A1.

The blade holder 1 further comprises a third holder member 4 that is rotatable relative to the second holder member 3 about the first adjustment axis A1. In particular, the third holder member 4 comprises a third holder body 40 and two angular adjustment bolts 41, 42 connected to said third holder body 40 and slidably engaged with the respective angular adjustment slots 31, 32 at the second holder body 30 for facilitating the aforementioned angular adjustment about the first adjustment axis A1. The angular adjustment bolts 41, 42 are fastened and/or tightened to releasably fixate the third holder body 40 relative to the second holder body 30 about the first adjustment axis A1 at the desired value or magnitude of the first angle H1.

The third holder member 4 is further provided with a third angular adjustment guide, in this example in the form of a physical angular adjustment shaft 43, extending at the third adjustment axis A3.

The blade holder 1 further comprises a fourth holder member 5 that is rotatable relative to the third holder member 4 about the third adjustment axis A3. In particular, the fourth holder member 5 is provided with a clamping section 51 for receiving and for rotatably connecting to the angular adjustment shaft 43 of the third holder member 4.

In this example, the clamping section 51 comprises a slit 52 that divides the fourth holder body 50 into two clamping jaws 53, 54 which can be moved towards each other to clampingly fixate the fourth holder body 50 on the angular adjustment shaft 43 at the desired value or magnitude of the third angle H3. More specifically, fixation bolts 55 are provided that can be fastened or tightened to move the two clamping jaws 53, 54 towards each other to fixate the third angle H3 and loosened to release the fixation and adjust the third angle H3.

The fourth holder member 5 holds, carries or supports the cutting blade 9. In particular, the converter 81 is fitted to, received or mounted at or in the fourth holder body 50. The cutting blade 9 and the fourth holder member 5 are thus configured to rotate about the third adjustment axis A3 as one or in unison. In other words, the orientation of the cutting blade 9 with respect to the fourth holder member 5 about the third adjustment axis A3 remains the same.

In this example, the mounting member 82 connects to the cutting blade 9 at the center line S of the blade body 90. Hence, in order to have the third adjustment axis A3 intersecting with the incision point P at the leading tip 92 of the cutting blade 9, the mounting member 82 is positioned relative to the fourth holder member 5 such that the center line S is parallel to, yet offset from the third adjustment axis A3 over an offset distance D that is equal to half of the width of the blade body 90 and/or half of the length of the cutting edge 91. The mounting member 82 is fixed against rotation relative to the fourth holder member 5 about the center line S and thus rotates together with said fourth holder member 5 about the third adjustment axis A3.

The blade holder 1 may optionally be provided with an angular scale or a protractor 61 displaying a range of degrees and an indicator 62 for indicating the angular orientation of one of the holder members 2, 4, 5 relative to said protractor 61. In this example, the protractor 61 is provided on the fourth holder body 50 and the indicator 62 is provided on the angular adjustment shaft 51 for reading the third angle H3.

In summary, the holder members 2, 3, 4, 5 as described above together form a chain of interconnected, articulating segments that provide the cutting blade 9, supported by the fourth holder member 5, with the degree of freedom to rotate about the respective adjustment axes A1, A2, A3, relative to the base 10.

Note that in this exemplary embodiment, the angular adjustment guides of the first holder member 2 and the fourth holder member 5 are formed by shafts 21, 51 physically extending at or coinciding with the respective adjustment axes A2, A3. In contrast, the third holder member 4 does not rotate about a physical shaft. Instead, the rotation of the third holder member 4 about the first adjustment axis A1 is obtained virtually, by providing the third angular adjustment guide at a position spaced apart from said first adjustment axis A1.

It will however be appreciated that the rotation of the first holder member 2 and the fourth holder member 5 about their respective adjustment axes A2, A3 may alternatively be obtained virtually in a way similar to the third holder member 4. Similarly, the third holder member 4 may alternatively be rotated about a shaft extending physically at or coinciding with the first adjustment axis A1, provided that said physical shaft does not interfere with the cutting process of the cutting device 100.

It will further be understood that many alternative mechanical solutions may be provided to the angular adjustment guides as shown, including but not limited to: slots, pins, rails, shafts, linkages, guide shoes, gears, and the like.

A method for adjusting the orientation of the cutting blade 9 using the aforementioned blade holder 1 and/or cutting device 100 will now be briefly elucidated with reference to FIGS. 1-4.

To prepare for cutting, the cutting blade 9 is fitted, mounted or provided at the blade holder 1. The cutting blade 9 is positioned relative to and/or held by said blade holder 1 in such a way that the leading tip 92 of the cutting edge 91 is coincident with or located at the incision point P. Depending on the configuration and/or dimensions of the cutting blade 9, the position of the first holder member 2 relative to the base 10 may be linearly adjusted in the height direction F to make sure that the incision point P is coincident with and/or located in the support plane V, in particular at the cutting line L within said support plane V.

When the cutting blade 9 is fitted, the method comprises the step of angularly adjusting the orientation of the cutting blade 9 about one or more of the adjustment axes A1, A2, A3, depending on the desired orientation of the cutting blade 9 in the cutting process for which the cutting device 1 is being prepared or configured.

When the cutting blade 9 is in the desired orientation, the cutting process may be initiated. As mentioned earlier, in this example, the cutting blade 9 is configured for ultrasonic cutting. During the cutting process, the cutting blade 9 cuts one or more tire components to length using the cutting blade 9.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

### LIST OF REFERENCE NUMERALS

1 blade holder
10 base
11 rotary bearing
2 first holder member
20 first holder body
21 angular adjustment shaft
22 height adjustment section
23 first height adjustment slot
24 second height adjustment slot
3 second holder member
30 second holder body
31 first angular adjustment slot
32 second angular adjustment slot
33 first height adjustment bolt
34 second height adjustment bolt
4 third holder member
40 third holder body
41 first angular adjustment bolt
42 second angular adjustment bolt
43 angular adjustment shaft
5 fourth holder member
50 fourth holder body
51 clamping section
52 slit
53 first clamping jaw
54 second clamping jaw
55 fixation bolt
61 protractor
62 angle indicator
81 converter
82 mounting member
9 cutting blade
90 blade body
91 cutting edge
92 leading tip
100 cutting device
101 cutting guide
102 anvil
200 known cutting device
201 known blade holder
A1 first adjustment axis
A2 second adjustment axis
A3 third adjustment axis
A201 known first adjustment axis
A202 known second adjustment axis
A203 known second adjustment axis
C cutting direction
D offset distance
E edge profile
F height direction
G depth direction
H1 first angle
H2 second angle
H3 third angle
K arc
L cutting line
P incision point
S center line
V support plane
M edge plane
X first orthogonal axis
Y second orthogonal axis
Z third orthogonal axis

1. A blade holder for holding a cutting blade relative to a cutting line, wherein the blade holder is configured for holding the cutting blade such that a cutting edge of said cutting blade obliquely intersects with the cutting line at an incision point, wherein the blade holder mechanically defines a first adjustment axis for angular adjustment of an orientation of the cutting blade about said first adjustment axis, wherein the first adjustment axis intersects with the incision point.

2. The blade holder according to claim 1, wherein the blade holder mechanically defines a second adjustment axis for angular adjustment of the orientation of the cutting blade about said second adjustment axis, wherein the second adjustment axis intersects with the incision point.

3. The blade holder according to claim 2, wherein the blade holder mechanically defines a third adjustment axis for angular adjustment of the orientation of the cutting blade about said third adjustment axis, wherein the third adjustment axis intersects with the incision point.

4. The blade holder according to claim 1, wherein the first adjustment axis extends in one of a horizontal direction, a vertical direction or an oblique direction.

5. The blade holder according to claim 2, wherein the first adjustment axis and the second adjustment axis extend in respective ones of a horizontal direction, a vertical direction and an oblique direction.

6. The blade holder according to claim 3, wherein the first adjustment axis extends in a horizontal direction, the second adjustment axis extends in a vertical direction and the third adjustment axis extends in an oblique direction.

7. The blade holder according to claim 1, wherein the cutting edge defines a straight edge profile, wherein the cutting blade has a blade body with a center line perpendicular to the edge profile, wherein the first adjustment axis extends in one of:
a horizontal direction in an edge plane coincident with the edge profile and perpendicular to the center line;
a vertical direction; and
a direction parallel to the center line.

8. The blade holder according to claim 2, wherein the cutting edge defines a straight edge profile, wherein the cutting blade has a blade body with a center line perpendicular to the edge profile, wherein the first adjustment axis and the second adjustment axis extend in respective ones of:
a horizontal direction in an edge plane coincident with the edge profile and perpendicular to the center line;
a vertical direction; and
a direction parallel to the center line.

9. The blade holder according to claim 3, wherein the cutting edge defines a straight edge profile, wherein the cutting blade has a blade body with a center line perpendicular to the edge profile, wherein:
the first adjustment axis extends in a horizontal direction in an edge plane coincident with the edge profile and perpendicular to the center line;
the second adjustment axis extends a vertical direction; and
the third adjustment axis extends in a direction parallel to the center line.

10. The blade holder according to claim 1, wherein the adjustment of the orientation of cutting blade about the first adjustment axis determines one of a skive angle, an angle of attack and an edge inclination angle.

11. The blade holder according to claim 2, wherein the adjustment of the orientation of cutting blade about the first adjustment axis and the second adjustment axis determine respective ones of a skive angle, an angle of attack and an edge inclination angle.

12. The blade holder according to claim 3, wherein the adjustment of the orientation of cutting blade about the first adjustment axis, the second adjustment axis and the third adjustment axis determine a skive angle, an angle of attack and an edge inclination angle, respectively.

13. The blade holder according to claim 1, wherein the blade holder comprises one or more angular adjustment guides for guiding the angular adjustment of the orientation of the cutting blade about at least the first adjustment axis.

14. The blade holder according to claim 13, wherein the one or more angular adjustment guides extend physically at least at the first adjustment axis.

15. The blade holder according to claim 13, wherein the one or more angular adjustment guides are spaced apart from at least the first adjustment axis.

16. The blade holder according to claim 13, wherein the blade holder comprises one or more holder members which are interconnected using the one or more angular adjustment guides so as to be movable with respect to each other about at least the first adjustment axis, wherein one holder member of the one or more holder members is configured for carrying the cutting blade.

17. The blade holder according to claim 1, wherein the blade holder comprises a height adjustment section for linearly adjusting a height of the cutting blade relative to the cutting line in a height direction.

18. The blade holder according to claim 1, wherein the blade holder comprises one or more instruments for reading one or more angles adjusted by the angular adjustment of the orientation of the cutting blade.

19. The blade holder according to claim 18, wherein the one or more instruments comprises at least one protractor.

20. A blade holder for holding a cutting blade relative to a cutting line, wherein the blade holder mechanically defines a first adjustment axis and a second adjustment axis for angular adjustment of an orientation of the cutting blade about said first adjustment axis and said second adjustment axis, respectively, wherein the first adjustment axis and the second adjustment axis intersect with an incision point, common to both the first adjustment axis and the second adjustment axis, at the cutting line.

21. The blade holder according to claim 20, wherein the blade holder mechanically defines a third adjustment axis for angular adjustment of an orientation of the cutting blade about said third adjustment axis, wherein the third adjustment axis intersects with the incision point, common to the first adjustment axis, the second adjustment axis and the third adjustment axis, at the cutting line.

22. A cutting device comprising the blade holder according to claim 1 and a cutting blade held by said blade holder, wherein the cutting blade has a cutting edge that defines an edge profile that intersects with the cutting line at the incision point.

23. The cutting device according to claim 22, wherein the cutting edge terminates with a leading tip at the incision point.

24. The cutting device according to claim 22, wherein the cutting blade is configured for ultrasonic cutting.

25. A method for adjusting an orientation of a cutting blade using the blade holder according to claim 1, wherein the method comprises the step of:
angularly adjusting the orientation of the cutting blade about the first adjustment axis.

26. The method according to claim 25, wherein the blade holder mechanically defines a second adjustment axis for angular adjustment of the orientation of the cutting blade about said second adjustment axis, wherein the second adjustment axis intersects with the incision point, wherein the method further comprises the step of:
angularly adjusting the orientation of the cutting blade about the second adjustment axis.

27. The method according to claim 26, wherein the blade holder mechanically defines a third adjustment axis for angular adjustment of the orientation of the cutting blade about said third adjustment axis, wherein the third adjustment axis intersects with the incision point, wherein the method further comprises the step of:
angularly adjusting the orientation of the cutting blade about the third adjustment axis.

28. The method according to claim 25, wherein the method further comprises the step of:
linearly adjusting a height of the cutting blade relative to the cutting line in a height direction.

29. The method according to claim 25, wherein the cutting blade is configured for ultrasonic cutting.

30. The method according to claim 25, wherein the method comprises the step of:
cutting one or more tire components to length using the cutting blade.

31. A cutting device comprising the blade holder according to claim 20 and a cutting blade held by said blade holder, wherein the cutting blade has a cutting edge that defines an edge profile that intersects with the cutting line at the incision point.

32. A cutting device according to claim 31, wherein the cutting edge terminates with a leading tip at the incision point.

33. A cutting device according to claim 31, wherein the cutting blade is configured for ultrasonic cutting.

34. A method for adjusting an orientation of a cutting blade using the blade holder according to claim 20, wherein the method comprises the step of:
angularly adjusting the orientation of the cutting blade about the first adjustment axis.

35. The method according to claim 34, wherein the blade holder mechanically defines a second adjustment axis for angular adjustment of the orientation of the cutting blade about said second adjustment axis, wherein the second adjustment axis intersects with the incision point, wherein the method further comprises the step of:
angularly adjusting the orientation of the cutting blade about the second adjustment axis.

36. The method according to claim 35, wherein the blade holder mechanically defines a third adjustment axis for angular adjustment of the orientation of the cutting blade about said third adjustment axis, wherein the third adjustment axis intersects with the incision point, wherein the method further comprises the step of:
angularly adjusting the orientation of the cutting blade about the third adjustment axis.

37. The method according to claim 34, wherein the method further comprises the step of:
linearly adjusting a height of the cutting blade relative to the cutting line in a height direction.

38. The method according to claim 34, wherein the cutting blade is configured for ultrasonic cutting.

39. The method according to claim 34, wherein the method comprises the step of:
cutting one or more tire components to length using the cutting blade.
